(19) United States
(12) Patent Application Publication
(10) Pub. No.: US 2023/0207966 A1
(43) Pub. Date: Jun. 29, 2023

(54) ELECTROCHEMICAL DEVICE AND ELECTRONIC DEVICE CONTAINING SAME

(71) Applicant: Ningde Amperex Technology Limited, Ningde City (CN)

(72) Inventors: Ao Liu, Ningde City (CN); Chao Gao, Ningde City (CN); Zhanzhao Fang, Ningde City (CN)

(73) Assignee: Ningde Amperex Technology Limited, Ningde City (CN)

(21) Appl. No.: 17/911,883

(22) PCT Filed: Mar. 18, 2020
(86) PCT No.: PCT/CN2020/080022

§ 371 Date: Sep. 15, 2022

(51) Int. Cl. H01M 50/46; H01M 10/0525; H01M 50/489; H01M 4/505; H01M 4/525; H01M 50/451

(52) U.S. Cl. CPC H01M 50/461; H01M 10/0525; H01M 50/489; H01M 4/505; H01M 4/525; H01M 50/451; H01M 2004/028

(57) ABSTRACT

An electrochemical device includes a positive electrode plate, a negative electrode plate, a separator, and an electrolytic solution. The positive electrode plate includes a positive active material having lithium transition metal oxide particles represented by a chemical formula LiₐCoₓM1_{y}M2_{z}O₂, where 0.95≤a≤1.05, 0.05<x<1, 0≤y≤0.9, 0<z≤0.2, x+y+z=1, an M1 is one or two selected from the group consisting of Ni and Mn, and an M2 is at least one selected from the group consisting of Mg, Al, Ti, La, Y, and Zr. The separator includes a porous substrate and a polymer adhesive layer. The polymer adhesive layer is disposed between the porous substrate and the positive electrode plate. An adhesive force of the polymer adhesive layer between the positive electrode plate is 3 N/m to 100 N/m.

### CROSS-REFERENCE TO RELATED APPLICATIONS

This application claims priority to PCT international application: PCT/CN2020/080022, filed on Mar. 18, 2020, the whole disclosure of which is incorporated herein by reference.

### TECHNICAL FIELD

This application relates to the electrochemical field, and in particular, to an electrochemical device and an electronic device containing same.

### BACKGROUND

Lithium-ion batteries are widely used in the field of consumer electronics by virtue of many advantages such as a high energy density, a long cycle life, a high nominal voltage, and a low self-discharge rate.

In recent years, with the gradual increase in an energy density of consumer lithium-ion batteries, a charge voltage limit of a positive active material also increases, thereby being prone to aggravate structural disruption and increase side reactions of the positive active material. A positive electrode plate is prone to produce gas, thereby causing thickness expansion of the lithium-ion batteries, and impairing high-voltage cycle capacity retention performance of the lithium-ion batteries.

### SUMMARY

An objective of this application is to provide an electrochemical device and an electronic device containing the electrochemical device to improve high-voltage cycle capacity retention performance of a lithium-ion battery. Specific technical solutions are as follows:

A first aspect of this application provides an electrochemical device, including a positive electrode plate, a negative electrode plate, a separator, and an electrolytic solution. The separator is disposed between the positive electrode plate and the negative electrode plate.

The positive electrode plate includes a positive active material, and the positive active material includes lithium transition metal oxide particles represented by a chemical formula LiₐCoₓM1_{y}M2_{z}O₂, where 0.95≤a≤1.05, 0.05<x<1, 0≤y≤0.9, 0<z≤0.2, x+y+z=1, M1 is one or two selected from the group consisting of Ni and Mn, and M2 is at least one selected from the group consisting of Mg, Al, Ti, La, Y, and Zr.

The separator includes a porous substrate and a polymer adhesive layer, the polymer adhesive layer is disposed between the porous substrate and the positive electrode plate, and an adhesive force of the polymer adhesive layer between the positive electrode plate is 3 N/m to 100 N/m.

In an implementation solution of this application, the lithium transition metal oxide particles are doped with the M2.

In an implementation solution of this application, based on a total weight of the positive active material, a content of the M2 is 1000 ppm to 20000 ppm.

In an implementation solution of this application, an oxide of the M2 is disposed on a surface of the lithium transition metal oxide particles, and the oxide of the M2 is at least one selected from the group consisting of Al₂O₃, MgO, TiO₂, La₂O₃, Y₂O₃, and ZrO₂.

In an implementation solution of this application, the positive active material satisfies the following relation:

1≤Dᵥ₉₉/Dᵥ₅₀≤2.

In the relational expression above, Dᵥ₉₉ is a particle diameter of the positive active material measured when a cumulative volume percentage of measured particles calculated from a small-diameter side reaches 99% of a total volume in a volume-based particle size distribution; and Dᵥ₅₀ is a particle diameter of the positive active material measured when the cumulative volume percentage of measured particles calculated from a small-diameter side reaches 50% of the total volume in the volume-based particle size distribution.

In an implementation solution of this application, the polymer adhesive layer includes polymer particles, and the polymer particles have at least one characteristic from the group consistings:

(a) the polymer particles are core-shell structures;

(b) an average particle diameter of the polymer particles is 200 nm to 2000 nm;

(c) a number of layers of the polymer particles in the polymer adhesive layer is less than or equal to 4; and

(d) a swelling degree of the polymer particles swollen in the electrolytic solution is 20% to 1000%.

In an implementation solution of this application, an areal percentage of an orthographic projection of the polymer adhesive layer on a surface of the porous substrate is 15% to 85%.

In an implementation solution of this application, the polymer particles include at least one of polyvinylidene dichloride, poly(vinylidene fluoride-co-hexafluoropropylene), poly(styrene-co-butadiene), polyacrylonitrile, poly(butadiene-co-acrylonitrile), polyacrylic acid, polyacrylate, or poly(acrylate-co-styrene).

In an implementation solution of this application, an inorganic compound layer is further included between the porous substrate and the polymer adhesive layer, and the inorganic compound layer includes inorganic particles and a binder.

A second aspect of this application provides an electronic device. The electronic device includes the electrochemical device according to the first aspect of this application.

In the electrochemical device and the electronic device containing the electrochemical device according to this application, the positive active material includes the lithium transition metal oxide particles represented by the chemical formula LiₐCoₓM1_{y}M2_{z}O₂, thereby effectively improving the structural stability of the positive active material, reducing dissolution of the Co element, and improving the high-voltage cycle capacity retention performance of the electrochemical device. In addition, a polymer adhesive layer that exerts an adhesive force of 3 N/m to 100 N/m on the positive electrode plate is disposed in the separator, thereby enhancing adhesion between the positive electrode plate and the separator, shortening an interlayer spacing between the positive electrode plate and the separator, reducing a reaction rate at an interface between the positive active material and the electrolytic solution, and in turn, suppressing gassing of the positive electrode and avoiding gassing-induced thickness expansion of the battery.

### DETAILED DESCRIPTION

To make the objectives, technical solutions, and advantages of this application clearer, the following describes this application in more detail. Evidently, the described embodiments are merely a part of but not all of the embodiments of this application. All other technical solutions derived by a person of ordinary skill in the art based on the embodiments of this application without making any creative effort fall within the protection scope of this application.

This application provides an electrochemical device, including a positive electrode plate, a negative electrode plate, a separator, and an electrolytic solution. The separator is disposed between the positive electrode plate and the negative electrode plate.

The positive electrode plate includes a positive active material, and the positive active material includes lithium transition metal oxide particles represented by a chemical formula LiₐCOₓM1_{y}M2_{z}O₂. In the lithium transition metal oxide particles, 0.95≤a≤1.05, 0.05<x<1,0≤y≤0.9, 0<z≤0.2, x+y+z=1, M1 is one or two selected from the group consisting of Ni and Mn, and M2 is at least one selected from the group consisting of Mg, Al, Ti, La, Y, and Zr. Definitely, any lithium cobalt oxide particles containing the M2 other than the lithium transition metal oxide particles represented by the chemical formula LiₐCoₓM1_{y}M2_{z}O₂ fall within the protection scope of this application.

The separator includes a porous substrate and a polymer adhesive layer, the polymer adhesive layer is disposed between the porous substrate and the positive electrode plate, and an adhesive force of the polymer adhesive layer between the positive electrode plate is 3 N/m to 100 N/m.

Through research, the inventor finds that, the M2 included in the lithium transition metal oxide particles can effectively improve the structural stability of the positive active material, and reduce dissolution of the Co element, thereby improving the high-voltage (for example, above 4.3 V) cycle capacity retention rate of the electrochemical device. However, with the increase of the M2 in the lithium transition metal oxide particles, a specific surface area of the positive active material increases, so that an effective reaction area between the positive electrode plate and the electrolytic solution increases and gassing is prone to occur. Based on this finding, this application disposes a high-adhesion polymer adhesive layer in the separator. The adhesive force of the polymer adhesive layer between the positive electrode plate is 3 N/m to 100 N/m. After the separator is infiltrated by the electrolytic solution, a relatively high adhesive force can still be maintained between the positive electrode plate and the separator. Because the polymer adhesive layer enhances the adhesion between the positive electrode plate and the separator, the interlayer spacing between the positive electrode plate and the separator is shortened, and the reaction rate at the interface between the positive active material and the electrolytic solution is reduced, thereby suppressing gassing of the positive electrode.

In an embodiment of this application, the lithium transition metal oxide particles may be doped with the M2, thereby improving the structural stability of the lithium transition metal oxide particles and reducing Co dissolution. For example, the lithium transition metal oxide particles are doped with an Mg element or an Al element, or both the Mg element and the Al element. Definitely, the lithium transition metal oxide particles may be doped with at least one of elements of Mg, Al, Ti, La, Y, or Zr instead of the examples given above.

In an implementation solution of this application, based on a total weight of the positive active material, the content of the M2 is 1000 ppm to 20000 ppm, and preferably, 2000 ppm to 15000 ppm. If the content of the M2 is deficient (for example, lower than 1000 ppm), the structural stability of the positive active material will be reduced, which is adverse to improving the high-voltage cycle capacity retention rate of electrochemical device. If the content of the M2 is excessive (for example, higher than 20000 ppm), the energy density of electrochemical device will be impaired, side reactions will occur, and the gassing problem will be severe.

In an implementation solution of this application, the oxide of the M2 is disposed on the surface of the lithium transition metal oxide particles. That is, the oxide of the M2 coats the surface of the lithium transition metal oxide particles to form a coating layer, thereby improving the structural stability of the lithium transition metal oxide particles and reducing Co dissolution.

In an implementation solution of this application, the oxide of the M2 is at least one selected from the group consisting of Al₂O₃, MgO, TiO₂, La₂O₃, Y₂O₃, and ZrO₂.

In an implementation solution of this application, the thickness of the coating layer formed by the oxide of the M2 is 5 nm to 200 nm, and preferably, 10 nm to 100 nm.

In an implementation solution of this application, the positive active material satisfies the following relational expression: 1≤Dᵥ₉₉/Dᵥ₅₀≤2, indicating that the particle size distribution of the positive active material is uniform, thereby reducing surface roughness of the positive electrode plate, and helping to keep uniformity of gaps between the positive electrode plate and the separator. In this way, a gas pressure of the gas generated by the side reactions is more equalized and stable between the gaps between the positive electrode plate and the separator. Because the side reactions are reversible reactions, chemical reactions in a forward direction of the side reactions are impeded, thereby inhibiting the side reactions from further generating gas, and reducing the production of gas. In addition, this can reduce gassing sites, thereby further reducing occurrence of gassing.

In the relational expression above, Dᵥ₉₉ is a particle diameter of the positive active material measured when a cumulative volume percentage of measured particles calculated from a small-diameter side reaches 99% of a total volume in a volume-based particle size distribution; and Dᵥ₅₀ is a particle diameter of the positive active material measured when the cumulative volume percentage of measured particles calculated from a small-diameter side reaches 50% of the total volume in the volume-based particle size distribution.

In an embodiment of this application, the ratio of Dᵥ₉₉ to Dᵥ₅₀ of the positive active material is preferably 1.1 to 1.7. This ratio range can further reduce the surface roughness of the positive electrode plate, thereby further reducing gas production.

In an implementation solution of this application, the polymer adhesive layer may include polymer particles. The polymer particles are core-shell structures, in which a shell can protect a core, thereby improving the structural stability of the polymer particles.

In an implementation solution of this application, an average diameter of the polymer particles is 200 nm to 2000 nm, and preferably, 300 nm to 1300 nm. The average diameter here may mean Dᵥ₅₀.

In an embodiment of this application, the number of layers of the polymer particles in the polymer adhesive layer is less than or equal to 4, and preferably, less than or equal to 2. Without being limited to any theory, as macroscopically shown, a relatively small number of layers can make the polymer adhesive layer thinner, thereby reducing an overall thickness of the separator and increasing the energy density of the battery. In addition, the relatively small number of layers can shorten an ion transmission distance between the positive electrode and the negative electrode, thereby improving the electrochemical performance of the lithium-ion battery. If the polymer particles are disposed in the polymer adhesive layer for an excessive number of layers, the overall thickness of the separator will increase, and the energy density of the battery will be impaired.

In an implementation solution of this application, the swelling degree of the polymer particles swollen in the electrolytic solution is 20% to 1000%, where the electrolytic solution means the electrolytic solution in the electrochemical device. If the swelling degree of the polymer particles swollen in the electrolytic solution of the electrochemical device is deficient (for example, lower than 20%), the adhesive force is limited, and the bonding effect is inferior. If the swelling degree of the polymer particles swollen in the electrolytic solution of the electrochemical device is excessive (for example, higher than 1000%), the morphology of the polymer particles will be affected, and the pores in the porous substrate will be blocked at local positions, thereby affecting ion transmission between the positive electrode and the negative electrode, and deteriorating the electrochemical performance of the electrochemical device.

In an implementation solution of this application, an areal percentage of an orthographic projection of the polymer adhesive layer on the surface of the porous substrate is 15% to 85%, and preferably, 30% to 70%. Without being limited to any theory, when the areal percentage of the orthographic projection of the polymer adhesive layer on the surface of the porous substrate is deficient, the adhesion between the positive electrode plate and the separator decreases, and an interlayer spacing is prone to occur between the positive electrode plate and the separator. When the areal percentage of the orthographic projection of the polymer adhesive layer on the surface of the porous substrate is excessive, ion permeability of the separator decreases, thereby affecting the transfer of lithium ions between the positive electrode and the negative electrode.

The polymer type of the polymer particles for use in this application is not particularly limited, as long as the objectives of this application can be achieved. In an implementation solution of this application, the polymer particles may include at least one of polyvinylidene dichloride, poly(vinylidene fluoride-co-hexafluoropropylene), poly(styrene-co-butadiene), polyacrylonitrile, poly(butadiene-co-acrylonitrile), polyacrylic acid, polyacrylate, or poly(acrylate-co-styrene).

In an implementation solution of this application, an inorganic compound layer may be further included between the porous substrate and the polymer adhesive layer. The inorganic compound layer serves to improve the heat resistance performance of the separator. The inorganic compound layer may include inorganic particles and a binder.

The inorganic particles and the binder for use in the inorganic compound layer of this application are not particularly limited, as long as the objectives of this application can be achieved. In an implementation solution of this application, the inorganic particles may include at least one of: aluminum oxide, silicon dioxide, magnesium oxide, titanium oxide, hafnium dioxide, tin oxide, ceria, nickel oxide, zinc oxide, calcium oxide, zirconium dioxide, yttrium oxide, silicon carbide, boehmite, aluminum hydroxide, magnesium hydroxide, calcium hydroxide, or barium sulfate. The binder may include at least one of a homopolymer of vinylidene difluoride, a copolymer of vinylidene difluoride, a copolymer of hexafluoropropylene, polystyrene, polyphenylene acetylene, sodium polyvinyl, potassium polyvinyl, polymethyl methacrylate, polyethylene, polypropylene, or polytetrafluoroethylene.

The material of the porous substrate of the separator according to this application is not particularly limited, as long as the objectives of this application can be achieved. In an implementation solution of this application, the material of the porous substrate may include at least one of polyethylene, polypropylene, polyethylene terephthalate, aramid fiber, cellulose, or polyimide.

In an implementation solution of this application, the polymer adhesive layer may further include auxiliary binder and a dispersant. The auxiliary binder and the dispersant for use in this application are not particularly limited, as long as the objectives of this application can be achieved. For example, the auxiliary binder may include polyvinylidene difluoride (PVDF), and the dispersant may include at least one of dimethylformamide (DMF), carboxymethyl cellulose (CMC), or polyvinylpyrrolidone (PVP).

The negative electrode plate in this application is not particularly limited as long as the negative electrode plate can achieve the objective of this application. For example, the negative electrode plate generally includes a negative current collector and a negative active material layer. The negative current collector is not particularly limited, and may be any negative current collector known in the art, for example, a copper foil, an aluminum foil, an aluminum alloy foil, or a composite current collector. The negative active material layer includes a negative active material. The negative active material is not particularly limited, and may be any negative active material known in the art. For example, the negative active material layer may include at least one of artificial graphite, natural graphite, mesocarbon microbead, soft carbon, hard carbon, silicon, silicon carbon, lithium titanate, or the like.

The electrolytic solution in this application is not particularly limited, and may be any electrolytic well known in the art. For example, the electrolytic solution may be in a gel state, or a solid state, or a liquid state. For example, the liquid-state electrolytic solution may include a lithium salt and a nonaqueous solvent.

The lithium salt is not particularly limited, and may be any lithium salt known in the art, as long as the objectives of this application can be achieved. For example, the lithium salt may be at least one selected from the group consisting of LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, and LiPO₂F₂. For example, the lithium salt may be LiPF₆.

The nonaqueous solvent is not particularly limited, as long as the objectives of this application can be achieved. For example, the nonaqueous solvent may be at least one selected from the group consisting of carbonate compound, a carboxylate compound, an ether compound, a nitrile compound, and another organic solvent.

For example, the carbonate compound may be at least one selected from the group consisting of diethyl carbonate (DEC), dimethyl carbonate (DMC), dipropyl carbonate (DPC), methyl propyl carbonate (MPC), ethylene propyl carbonate (EPC), ethylene carbonate (EC), propylene carbonate (PC), butylene carbonate (BC), vinyl ethylene carbonate (VEC), fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methyl ethylene, 1-fluoro-1-methyl ethylene carbonate, 1,2-difluoro-1-methyl ethylene carbonate, 1,1,2-trifluoro-2-methyl ethylene carbonate, and trifluoromethyl ethylene carbonate.

The material of the current collector according to this application is not particularly limited, and may be a material well known to those skilled in the art. For example, the material is at least one of copper, nickel, titanium, molybdenum, aluminum, iron, zinc, stainless steel, or an alloy thereof. Alternatively, the material of the current collector is a conductive inorganic material, for example, at least one of carbon or graphene.

In the electrochemical device according to this application, the positive active material includes the lithium transition metal oxide particles represented by the chemical formula LiaCoₓM1_{y}M2_{z}O₂, thereby effectively improving the structural stability of the positive active material, reducing dissolution of the Co element, and improving the high-voltage cycle capacity retention performance of the electrochemical device. In addition, a polymer adhesive layer that exerts an adhesive force of 3 N/m to 100 N/m on the positive electrode plate is disposed in the separator, thereby enhancing adhesion between the positive electrode plate and the separator, shortening an interlayer spacing between the positive electrode plate and the separator, reducing a reaction rate at an interface between the positive active material and the electrolytic solution, and in turn, suppressing gassing of the positive electrode and avoiding gassing-induced thickness expansion of the battery.

This application further provides a method for preparing an electrochemical device, including the following steps:

Preparing a Positive Electrode Plate:

Coating a positive current collector with a positive slurry, and performing steps of drying, cold pressing, and cutting to obtain a positive electrode plate, where the positive slurry is prepared by mixing lithium transition metal oxide particles, conductive carbon black, carbon nanotubes, and polyvinylidene difluoride in a N-methylpyrrolidone solution, and the chemical formula of the lithium transition metal oxide particles is LiₐCoₓM1_{y}M2_{z}O₂, where 0.95≤a≤1.05, 0.05<x<1, 0≤y≤0.9, 0<z≤0.2, x+y+z=1, M1 is one or two selected from the group consisting of Ni and Mn, and M2 is at least one selected from the group consisting of Mg, Al, Ti, La, Y, and Zr.

Preparing a negative Electrode Plate:

Coating a negative current collector with a negative slurry, and performing steps of drying, cold pressing, and cutting to obtain a negative electrode plate, where, the negative slurry is prepared by mixing artificial graphite, styrene butadiene rubber, and sodium carboxymethyl cellulose in deionized water.

Preparing an electrolytic solution:

Mixing lithium hexafluorophosphate and an organic solvent to obtain an electrolytic solution, where the organic solvent includes at least one of ethylene carbonate, diethyl carbonate, propylene carbonate, propyl propionate, or vinylene carbonate.

Preparing a polymer adhesive layer separator:

Using a polymer film as a porous substrate, mixing polymer particles with deionized water to obtain a polymer adhesive layer glue, coating both sides of the porous substrate with the polymer adhesive layer glue by screen-printing, and drying to obtain a separator with both sides coated with the polymer adhesive layer.

Preparing an Electrochemical Device:

Stacking the positive electrode plate, the negative electrode plate, and the separator sequentially in such a way that the separator is located between the positive electrode plate and the negative electrode plate, and then winding the stacked plates into an electrode assembly. Subsequently, putting the electrode assembly into an aluminum plastic film packaging bag, and dehydrating to obtain a dry electrode assembly, injecting the electrolytic solution into the dry electrode assembly, and performing steps of vacuum packaging, standing, chemical formation, and shaping to obtain an electrochemical device.

In the electrochemical device manufactured by using the method for preparing an electrochemical device according to this application, the lithium transition metal oxide particles represented by the chemical formula LiₐCOₓM1_{y}M2_{z}O₂ are added into the positive electrode plate, thereby effectively improving the structural stability of the positive active material. An adhesive layer that exerts an adhesive force of 3 N/m to 100 N/m is disposed on the separator, thereby shortening an interlayer spacing between the positive electrode plate and the separator, reducing a reaction rate at an interface between the positive active material and the electrolytic solution, and avoiding gassing-induced thickness expansion of the battery in the prepared electrochemical device.

This application further provides an electronic device, including the electrochemical device described in the foregoing implementation solution. In the electrochemical device used in the electronic device, the positive active material includes the lithium transition metal oxide particles represented by the chemical formula LiaCoₓM1_{y}M2_{z}O₂, thereby effectively improving the structural stability of the positive active material, reducing dissolution of the Co element. In addition, a polymer adhesive layer that exerts an adhesive force of 3 N/m to 100 N/m on the positive electrode plate is disposed in the separator, thereby enhancing adhesion between the positive electrode plate and the separator, shortening an interlayer spacing between the positive electrode plate and the separator, reducing a reaction rate at an interface between the positive active material and the electrolytic solution, avoiding gassing-induced thickness expansion of the battery, and improving safety of the electronic device.

The implementations of this application are described below in more detail with reference to embodiments and comparative embodiments. Various tests and evaluations are performed in accordance with the following methods. In addition, unless otherwise specified, “fraction” and “%” mean a percent by weight.

### Embodiment 1

<Preparing a Positive Electrode Plate>

Dissolving lithium transition metal oxide particles (lithium cobalt oxide), conductive carbon black, carbon nanotubes, and polyvinylidene difluoride in an N-methylpyrrolidone solution at a weight ratio of 96:0.5:0.5:3 to obtain a positive slurry, where the lithium transition metal oxide particles are doped with Al in an amount of 1000 ppm, a coating substance in the lithium transition metal oxide particles is Al₂O₃, the thickness of the coating layer is 10 nm, and the Dᵥ₉₉/D_{y} so ratio is 2.0. Using an aluminum foil as a positive current collector. Coating the positive current collector with the positive slurry, performing steps of drying and cold pressing, and then cutting the positive electrode plate into sheets of 74 mm to 867 mm in size ready for use.

<Preparing a Negative Electrode Plate>

Dissolving artificial graphite, styrene butadiene rubber, and sodium carboxymethyl cellulose in deionization at a weight ratio of 98:1.0:1.0 to obtain a negative slurry. Using a copper foil as a negative current collector, and coating the negative current collector with the negative slurry. Performing drying and cold pressing, and cutting the negative electrode plate into sheets of 74 mm to 867 mm in size ready for use.

<Preparing an Electrolytic Solution>

Blending lithium hexafluorophosphate and an organic solvent at a weight ratio of 8:92 in an environment with a moisture content of less than 10 ppm to form an electrolytic solution, where the organic solvent is obtained by mixing ethylene carbonate, diethyl carbonate, propylene carbonate, propyl propionate, and vinylene carbonate at a weight ratio of 20:30:20:28:2.

<Preparing a Separator>

<Preparing a Polymer Adhesive Layer Glue>

Selecting a poly(acrylate-co-acrylic acid) with a solid content of 40%, mixing the poly(acrylate-co-acrylic acid) with deionized water at a weight ratio of 25:75, and stirring at 45° C. for 2 hours to obtain a polymer adhesive layer glue, where the stirring device is a double planetary mixer.

<Preparing a Separator>

Using a 9 pm-thick polyethylene film as a porous substrate, and coating both sides of the porous substrate with the polymer adhesive layer glue at a coating speed of 5 m/min by screen-printing, and then drying at a temperature of 60° C. to obtain a separator coated with a polymer adhesive layer on both sides. The polymer particles contained in the polymer adhesive layer are polyacrylic acid (that is, poly(acrylate-co-acrylic acid)). An average diameter (Dᵥ₅₀) of the polymer particles contained in the polymer adhesive layer is 500 nm. The polymer particles are core-shell structures. The adhesive force of the polymer adhesive layer between the positive electrode plate is 4.3 N/m. The areal percentage of an orthographic projection of the polymer adhesive layer on the surface of the porous substrate is 30%.

<Preparing an Electrochemical Device>

Stacking the positive electrode plate, the negative electrode plate, and the separator sequentially in such a way that the separator is located between the positive electrode plate and the negative electrode plate, and then winding the stacked plates into an electrode assembly. Subsequently, putting the electrode assembly into an aluminum plastic film packaging bag, and dehydrating to obtain a dry electrode assembly, injecting the electrolytic solution into the dry electrode assembly, and performing steps of vacuum packaging, standing, chemical formation, and shaping to obtain an electrochemical device. A swelling degree of the polymer particles swollen in the electrolytic solution of the electrochemical device is 62%.

### Embodiment 2

Identical to Embodiment 1 except that the Al doping content in the lithium transition metal oxide particles is 2000 ppm.

### Embodiment 3

Identical to Embodiment 1 except that the Al doping content in the lithium transition metal oxide particles is 15000 ppm.

### Embodiment 4

Identical to Embodiment 1 except that the Al doping content in the lithium transition metal oxide particles is 20000 ppm.

### Embodiment 5

Identical to Embodiment 4 except that the thickness of the Al₂O₃ coating layer in the lithium transition metal oxide particles is 5 nm.

### Embodiment 6

Identical to Embodiment 4 except that the thickness of the Al₂O₃ coating layer in the lithium transition metal oxide particles is 100 nm.

### Embodiment 7

Identical to Embodiment 4 except that the thickness of the Al₂O₃ coating layer in the lithium transition metal oxide particles is 200 nm.

### Embodiment 8

Identical to Embodiment 7 except that the coating substance is MgO.

### Embodiment 9

Identical to Embodiment 7 except that the doping element is Mg.

### Embodiment 10

Identical to Embodiment 7 except that the doping element is Mg and the coating substance is MgO.

### Embodiment 11

Identical to Embodiment 7 except that the average diameter of the polymer particles is 200 nm and the coating substance is MgO.

### Embodiment 12

Identical to Embodiment 11 except that the average diameter of the polymer particles is 300 nm.

### Embodiment 13

Identical to Embodiment 11 except that the average diameter of the polymer particles is 1000 nm.

### Embodiment 14

Identical to Embodiment 11 except that the average diameter of the polymer particles is 2000 nm.

### Embodiment 15

Identical to Embodiment 7 except that the areal percentage of the orthographic projection of the polymer adhesive layer on the surface of the porous substrate is 15%.

### Embodiment 16

Identical to Embodiment 7 except that the areal percentage of the orthographic projection of the polymer adhesive layer on the surface of the porous substrate is 20%.

### Embodiment 17

Identical to Embodiment 7 except that the areal percentage of the orthographic projection of the polymer adhesive layer on the surface of the porous substrate is 40%.

### Embodiment 18

Identical to Embodiment 7 except that the areal percentage of the orthographic projection of the polymer adhesive layer on the surface of the porous substrate is 50%.

### Embodiment 19

Identical to Embodiment 7 except that the areal percentage of the orthographic projection of the polymer adhesive layer on the surface of the porous substrate is 60%.

### Embodiment 20

Identical to Embodiment 7 except that the areal percentage of the orthographic projection of the polymer adhesive layer on the surface of the porous substrate is 70%.

### Embodiment 21

Identical to Embodiment 7 except that the areal percentage of the orthographic projection of the polymer adhesive layer on the surface of the porous substrate is 80%.

### Embodiment 22

Identical to Embodiment 7 except that the areal percentage of the orthographic projection of the polymer adhesive layer on the surface of the porous substrate is 85%.

### Embodiment 23

Identical to Embodiment 18 except that the porous substrate is a polypropylene (PP) film.

### Embodiment 24

Identical to Embodiment 18 except that the porous substrate is a polyethylene terephthalate (PET) film.

### Embodiment 25

Identical to Embodiment 18 except that the porous substrate is a cellulose film.

### Embodiment 26

Identical to Embodiment 18 except that the porous substrate is a polyimide (PI) film.

### Embodiment 27

Identical to Embodiment 18 except that the polymer particles contained in the polymer adhesive layer are polyvinylidene difluoride.

### Embodiment 28

Identical to Embodiment 18 except that the polymer particles contained in the polymer adhesive layer is poly(styrene-co-butadiene).

### Embodiment 29

Identical to Embodiment 18 except that the polymer particles contained in the polymer adhesive layer are polyacrylonitrile.

### Embodiment 30

Identical to Embodiment 18 except that the polymer particles contained in the polymer adhesive layer are polyacrylate.

### Embodiment 31

Identical to Embodiment 18 except that the polymer particles contained in the polymer adhesive layer are poly(acrylate-co-styrene).

### Embodiment 32

Identical to Embodiment 31 except that the Dᵥ₉₉/Dᵥ₅₀ ratio of the positive active material is 1.5.

### Embodiment 33

Identical to Embodiment 31 except that the Dᵥ₉₉/Dᵥ₅₀ ratio of the positive active material is 1.0.

### Comparative Embodiment 1

Identical to Embodiment 1 except that the polymer particles contained in the polymer adhesive layer are polyvinylidene difluoride, the average diameter of the polymer particles is 100 nm, the lithium transition metal oxide particles (lithium cobalt oxide) are undoped and uncoated, and the Dᵥ₉₉/Dᵥ so ratio of the positive active material is 3.0.

### Comparative Embodiment 2

Identical to Embodiment 1 except that the polymer particles contained in the polymer adhesive layer are polyvinylidene difluoride, the average diameter of the polymer particles is 100 nm, the content of the Al dopant in the lithium transition metal oxide particles (lithium cobalt oxide) is 3000 ppm, and the Dᵥ₉₉/Dᵥ₅₀ ratio of the positive active material is 3.0.

### Comparative Embodiment 3

Identical to Embodiment 1 except that the lithium transition metal oxide particles are undoped and uncoated, and the Dᵥ₉₉/Dᵥ₅₀ ratio of the positive active material is 3.0.

<Performance Test>

The electrochemical devices prepared in Embodiments 1 to 33 and Comparative Embodiments 1 to 3 are tested for performance according to the following methods:

<Co Dissolution Amount>

Measuring the Co content on the surfaces of the separator and the negative electrode by using ICP (Inductive Coupled Plasma Emission Spectrometer, inductively coupled plasma emission spectrometry), and using the Co content to represent the Co dissolution amount of the lithium transition metal oxide (such as lithium cobalt oxide) in the positive electrode plate, so as to reflect the structural stability of the lithium transition metal oxide in the positive electrode plate. A smaller Co dissolution amount represents a more stable structure.

<Cycle Capacity Retention Rate>

Performing the same charging process for all the comparative embodiments and the embodiments at an ambient temperature of 25° C.: charging the battery at a constant current of 0.7 C in the constant-current charging stage until the voltage reaches the cut-off voltage of 4.5 V; and then charging the battery at a constant voltage until the current reaches the cut-off current of 0.05 C; leaving the battery to stand for 5 minutes whenever the battery enters a fully charged state, and then discharging the battery at a current of 0.5 C until the voltage reaches 3.0 V, thereby completing a charge-and-discharge cycle. Repeating the charge-and-discharge cycle until 500 cycles are completed, and then dividing a 500th-cycle discharge capacity by a first-cycle discharge capacity to obtain a cycle capacity retention rate.

<Cycle Thickness Growth Rate>

Performing the same charge-and-discharge process as described in the foregoing cycle capacity retention rate test for all the comparative embodiments and embodiments until 500 cycles are completed, calculating a difference between the thickness at the end of 500 cycles and an initial thickness (the thickness before the first cycle), dividing the difference by the initial thickness of the battery to obtain a cycle thickness growth rate. A smaller cycle thickness growth rate represents higher performance.

<Hot Oven Test Pass Rate at 130° C. after Cycles>

Performing the same charge-and-discharge process as described in the foregoing cycle capacity retention rate test for all the comparative embodiments and embodiments until 500 cycles are completed, charging the battery at a normal temperature until a fully charged state after the 500 cycles, and then storing the battery in a 130° C. environment for 1 hour. A battery that does not catch fire or explode is regarded as passing the test. The pass rate in each test is obtained by dividing the number of batteries passing the test by the total number of batteries tested. A higher pass rate represents higher performance.

<Testing the Adhesive Force>

Discharging the electrochemical devices prepared in the comparative embodiments and the embodiments at a constant current rate of 1 C until the voltage reaches 3.0 V, and disassembling the batteries. Cutting out a 100 mm×10 mm rectangular sample off the positive electrode plate, the separator, and the negative electrode plate separately by using a cutter. Sticking the sample onto a stainless steel sheet by using double-sided tape. Testing the adhesive force between the positive electrode plate and the separator by peeling off the separator along a 180-degree angle at a speed of 300 mm/min until a length of 40 mm is tested.

<Areal Percentage of the Orthographic Projection of the Polymer Adhesive Layer on the Surface of the Porous Substrate>

Using a reflectance infrared spectrometer (model: Nioleti S10) to characterize the integrated area ratio between the characteristic peak of the porous substrate before being coated with the polymer adhesive layer and the characteristic peak of the porous substrate after being coated, so as to obtain an areal percentage of the orthographic projection of the polymer adhesive layer on the surface of the porous substrate according to the following formula: the areal percentage of the orthographic projection=(1—area of the characteristic peak of the porous substrate coated with the polymer adhesive layer/area of the characteristic peak of the porous substrate uncoated with the polymer adhesive layer)×100%.

<Testing Particle Diameters of the Polymer Particles in the Polymer Adhesive Layer and the Positive Active Material>

Testing the particle morphology and the number of packing layers of the polymer adhesive layer by using a scanning electron microscope (model: ZEISS Sigma/X-max). The particle morphology may be determined by scanning the surface morphology of the separator. The number of packing layers may be determined by making a cross section of the separator through ion beam cross-section polishing and then scanning the cross section with the scanning electron microscope. The particle size distributions of the polymer particles in the polymer adhesive layer and the positive active material may be tested by a laser particle size analyzer (model: Mastersizer 3000), so as to obtain Dᵥ₅₀ and Dᵥ₉₉.

The preparation parameters and test results of the embodiments and comparative embodiments are shown in Table 1 and Table 2 below:

TABLE 1
Preparation parameters and test results of embodiments and comparative embodiments

| | | | | | | Areal | | |
|---|---|---|---|---|---|---|---|---|
| | | | | | | percentage of | | |
| | | | | Average | | orthographic | Adhesive | |
| | | | | diameter of | | projection of | force to | |
| | | | Polymer | polymer | | polymer | positive | |
| | Separator | Separator | adhesive | particles | | adhesive | electrode | |
| | type | substrate | layer | (Dᵥ₅₀) | | layer | plate | |
| Embodiment 1 | High- | Polyethylene | Polyacrylic | 500 | nm | 30% | 4.3 | N/m |
| | adhesion | | acid | | | | | |
| | separator | | | | | | | |
| Embodiment 2 | High- | Polyethylene | Polyacrylic | 500 | nm | 30% | 4.3 | N/m |
| | adhesion | | acid | | | | | |
| | separator | | | | | | | |
| Embodiment 3 | High- | Polyethylene | Polyacrylic | 500 | nm | 30% | 4.3 | N/m |
| | adhesion | | acid | | | | | |
| | separator | | | | | | | |
| Embodiment 4 | High- | Polyethylene | Polyacrylic | 500 | nm | 30% | 4.3 | N/m |
| | adhesion | | acid | | | | | |
| | separator | | | | | | | |
| Embodiment 5 | High- | Polyethylene | Polyacrylic | 500 | nm | 30% | 4.3 | N/m |
| | adhesion | | acid | | | | | |
| | separator | | | | | | | |
| Embodiment 6 | High- | Polyethylene | Polyacrylic | 500 | nm | 30% | 4.3 | N/m |
| | adhesion | | acid | | | | | |
| | separator | | | | | | | |
| Embodiment 7 | High- | Polyethylene | Polyacrylic | 500 | nm | 30% | 4.3 | N/m |
| | adhesion | | acid | | | | | |
| | separator | | | | | | | |
| Embodiment 8 | High- | Polyethylene | Polyacrylic | 500 | nm | 30% | 4.3 | N/m |
| | adhesion | | acid | | | | | |
| | separator | | | | | | | |
| Embodiment 9 | High- | Polyethylene | Polyacrylic | 500 | nm | 30% | 4.3 | N/m |
| | adhesion | | acid | | | | | |
| | separator | | | | | | | |
| Embodiment 10 | High- | Polyethylene | Polyacrylic | 500 | nm | 30% | 4.3 | N/m |
| | adhesion | | acid | | | | | |
| | separator | | | | | | | |
| Embodiment 11 | High- | Polyethylene | Polyacrylic | 200 | nm | 30% | 4.4 | N/m |
| | adhesion | | acid | | | | | |
| | separator | | | | | | | |
| Embodiment 12 | High- | Polyethylene | Polyacrylic | 300 | nm | 30% | 4.9 | N/m |
| | adhesion | | acid | | | | | |
| | separator | | | | | | | |
| Embodiment 13 | High- | Polyethylene | Polyacrylic | 1000 | nm | 30% | 7.8 | N/m |
| | adhesion | | acid | | | | | |
| | separator | | | | | | | |
| Embodiment 14 | High- | Polyethylene | Polyacrylic | 2000 | nm | 30% | 10.9 | N/m |
| | adhesion | | acid | | | | | |
| | separator | | | | | | | |
| Embodiment 15 | High- | Polyethylene | Polyacrylic | 500 | nm | 15% | 3.0 | N/m |
| | adhesion | | acid | | | | | |
| | separator | | | | | | | |
| Embodiment 16 | High- | Polyethylene | Polyacrylic | 500 | nm | 20% | 3.7 | N/m |
| | adhesion | | acid | | | | | |
| | separator | | | | | | | |
| Embodiment 17 | High- | Polyethylene | Polyacrylic | 500 | nm | 40% | 5.2 | N/m |
| | adhesion | | acid | | | | | |
| | separator | | | | | | | |
| Embodiment 18 | High- | Polyethylene | Polyacrylic | 500 | nm | 50% | 6.6 | N/m |
| | adhesion | | acid | | | | | |
| | separator | | | | | | | |
| Embodiment 19 | High- | Polyethylene | Polyacrylic | 500 | nm | 60% | 8.7 | N/m |
| | adhesion | | acid | | | | | |
| | separator | | | | | | | |
| Embodiment 20 | High- | Polyethylene | Polyacrylic | 500 | nm | 70% | 10.1 | N/m |
| | adhesion | | acid | | | | | |
| | separator | | | | | | | |
| Embodiment 21 | High- | Polyethylene | Polyacrylic | 500 | nm | 80% | 11.3 | N/m |
| | adhesion | | acid | | | | | |
| | separator | | | | | | | |
| Embodiment 22 | High- | Polyethylene | Polyacrylic | 500 | nm | 85% | 12 | N/m |
| | adhesion | | acid | | | | | |
| | separator | | | | | | | |
| Embodiment 23 | High- | Polypropylene | Polyacrylic | 500 | nm | 50% | 6.4 | N/m |
| | adhesion | | acid | | | | | |
| | separator | | | | | | | |
| Embodiment 24 | High- | PET | Polyacrylic | 500 | nm | 50% | 6.3 | N/m |
| | adhesion | | acid | | | | | |
| | separator | | | | | | | |
| Embodiment 25 | High- | Cellulose | Polyacrylic | 500 | nm | 50% | 6.5 | N/m |
| | adhesion | | acid | | | | | |
| | separator | | | | | | | |
| Embodiment 26 | High- | Polyimide | Polyacrylic | 500 | nm | 50% | 6.4 | N/m |
| | adhesion | | acid | | | | | |
| | separator | | | | | | | |
| Embodiment 27 | High- | Polyethylene | Polyvinylidene | 500 | nm | 50% | 6.2 | N/m |
| | adhesion | | difluoride | | | | | |
| | separator | | | | | | | |
| Embodiment 28 | High- | Polyethylene | Poly(styrene- | 500 | nm | 50% | 6.5 | N/m |
| | adhesion | | co-butadiene) | | | | | |
| | separator | | | | | | | |
| Embodiment 29 | High- | Polyethylene | Polyacrylonitrile | 500 | nm | 50% | 6.3 | N/m |
| | adhesion | | | | | | | |
| | separator | | | | | | | |
| Embodiment 30 | High- | Polyethylene | Polyacrylic | 500 | nm | 50% | 6.1 | N/m |
| | adhesion | | ester | | | | | |
| | separator | | | | | | | |
| Embodiment 31 | High- | Polyethylene | Poly(acrylate- | 500 | nm | 50% | 6.3 | N/m |
| | adhesion | | co-styrene) | | | | | |
| | separator | | | | | | | |
| Embodiment 32 | High- | Polyethylene | Poly(acrylate- | 500 | nm | 50% | 6.3 | N/m |
| | adhesion | | co-styrene) | | | | | |
| | separator | | | | | | | |
| Embodiment 33 | High- | Polyethylene | Poly(acrylate- | 500 | nm | 50% | 6.3 | N/m |
| | adhesion | | co-styrene) | | | | | |
| | separator | | | | | | | |
| Comparative | Low- | Polyethylene | PVDF | 100 | nm | 30% | 1.0 | N/m |
| Embodiment 1 | adhesion | | | | | | | |
| | separator | | | | | | | |
| Comparative | Low- | Polyethylene | PVDF | 100 | nm | 30% | 1.0 | N/m |
| Embodiment 2 | adhesion | | | | | | | |
| | separator | | | | | | | |
| Comparative | High- | Polyethylene | Polyacrylic | 500 | nm | 30% | 4.0 | N/m |
| Embodiment 3 | adhesion | | acid | | | | | |
| | separator | | | | | | | |

| | | | | Type of | | | |
|---|---|---|---|---|---|---|---|
| | | Content of | | coating | | Coating | |
| | Doping | doping | | metal | Dᵥ₉₉/ | layer | |
| | element | element | | oxide | Dᵥ₅₀ | thickness | |
| Embodiment 1 | Al | 1000 | ppm | Al₂O₃ | 2 | 10 | nm |
| Embodiment 2 | Al | 2000 | ppm | Al₂O₃ | 2 | 10 | nm |
| Embodiment 3 | Al | 15000 | ppm | Al₂O₃ | 2 | 10 | nm |
| Embodiment 4 | Al | 20000 | ppm | Al₂O₃ | 2 | 10 | nm |
| Embodiment 5 | Al | 20000 | ppm | Al₂O₃ | 2 | 5 | nm |
| Embodiment 6 | Al | 20000 | ppm | Al₂O₃ | 2 | 100 | nm |
| Embodiment 7 | Al | 20000 | ppm | Al₂O₃ | 2 | 200 | nm |
| Embodiment 8 | Al | 20000 | ppm | MgO | 2 | 200 | nm |
| Embodiment 9 | Mg | 20000 | ppm | Al₂O₃ | 2 | 200 | nm |
| Embodiment 10 | Mg | 20000 | ppm | MgO | 2 | 200 | nm |
| Embodiment 11 | Al | 20000 | ppm | MgO | 2 | 200 | nm |
| Embodiment 12 | Al | 20000 | ppm | MgO | 2 | 200 | nm |
| Embodiment 13 | Al | 20000 | ppm | MgO | 2 | 200 | nm |
| Embodiment 14 | Al | 20000 | ppm | MgO | 2 | 200 | nm |
| Embodiment 15 | Al | 20000 | ppm | Al₂O₃ | 2 | 200 | nm |
| Embodiment 16 | Al | 20000 | ppm | Al₂O₃ | 2 | 200 | nm |
| Embodiment 17 | Al | 20000 | ppm | Al₂O₃ | 2 | 200 | nm |
| Embodiment 18 | Al | 20000 | ppm | Al₂O₃ | 2 | 200 | nm |
| Embodiment 19 | Al | 20000 | ppm | Al₂O₃ | 2 | 200 | nm |
| Embodiment 20 | Al | 20000 | ppm | Al₂O₃ | 2 | 200 | nm |
| Embodiment 21 | Al | 20000 | ppm | Al₂O₃ | 2 | 200 | nm |
| Embodiment 22 | Al | 20000 | ppm | Al₂O₃ | 2 | 200 | nm |
| Embodiment 23 | Al | 20000 | ppm | Al₂O₃ | 2 | 200 | nm |
| Embodiment 24 | Al | 20000 | ppm | Al₂O₃ | 2 | 200 | nm |
| Embodiment 25 | Al | 20000 | ppm | Al₂O₃ | 2 | 200 | nm |
| Embodiment 26 | Al | 20000 | ppm | Al₂O₃ | 2 | 200 | nm |
| Embodiment 27 | Al | 20000 | ppm | Al₂O₃ | 2 | 200 | nm |
| Embodiment 28 | Al | 20000 | ppm | Al₂O₃ | 2 | 200 | nm |
| Embodiment 29 | Al | 20000 | ppm | Al₂O₃ | 2 | 200 | nm |
| Embodiment 30 | Al | 20000 | ppm | Al₂O₃ | 2 | 200 | nm |
| Embodiment 31 | Al | 20000 | ppm | Al₂O₃ | 2 | 200 | nm |
| Embodiment 32 | Al | 20000 | ppm | Al₂O₃ | 1.5 | 200 | nm |
| Embodiment 33 | Al | 20000 | ppm | Al₂O₃ | 1.0 | 200 | nm |
| Comparative | — | — | | — | 3.0 | — | |
| Embodiment 1 | | | | | | | |
| Comparative | Al | 3000 | ppm | Al₂O₃ | 3.0 | 10 | nm |
| Embodiment 2 | | | | | | | |

| | | | | | |
|---|---|---|---|---|---|
| Comparative | — | — | — | 3.0 | — |
| Embodiment 3 | | | | | |

TABLE 2
Test results of electrochemical devices prepared
in embodiments and comparative embodiments

| | | | | | Hot oven test |
|---|---|---|---|---|---|
| | Co dissolution | | Cycle capacity | Cycle thickness | pass rate at |
| | amount | | retention rate | growth rate | 130° C. after cycles |
| Embodiment 1 | 3623 | ppm | 75% | 11.1% | 86% |
| Embodiment 2 | 3230 | ppm | 78% | 10.9% | 88% |
| Embodiment 3 | 2121 | ppm | 80% | 10.4% | 93% |
| Embodiment 4 | 1241 | ppm | 83% | 10.1% | 94% |
| Embodiment 5 | 1014 | ppm | 84% | 9.9% | 88% |
| Embodiment 6 | 781 | ppm | 86% | 9.8% | 91% |
| Embodiment 7 | 629 | ppm | 86% | 9.9% | 93% |
| Embodiment 8 | 682 | ppm | 85% | 9.8% | 92% |
| Embodiment 9 | 634 | ppm | 86% | 9.8% | 89% |
| Embodiment 10 | 611 | ppm | 84% | 9.7% | 92% |
| Embodiment 11 | 612 | ppm | 85% | 9.5% | 93% |
| Embodiment 12 | 638 | ppm | 86% | 9.2% | 95% |
| Embodiment 13 | 642 | ppm | 83% | 8.8% | 97% |
| Embodiment 14 | 627 | ppm | 85% | 8.5% | 100% |
| Embodiment 15 | 3593 | ppm | 71% | 14.4% | 81% |
| Embodiment 16 | 3576 | ppm | 73% | 12.3% | 84% |
| Embodiment 17 | 3629 | ppm | 77% | 10.6% | 87% |
| Embodiment 18 | 3631 | ppm | 78% | 10.1% | 90% |
| Embodiment 19 | 3636 | ppm | 80% | 9.5% | 92% |
| Embodiment 20 | 3628 | ppm | 82% | 9.2% | 95% |
| Embodiment 21 | 3620 | ppm | 85% | 8.8% | 98% |
| Embodiment 22 | 3620 | ppm | 88% | 8.6% | 100% |
| Embodiment 23 | 3597 | ppm | 78% | 10.1% | 90% |
| Embodiment 24 | 3619 | ppm | 76% | 10.0% | 91% |
| Embodiment 25 | 3610 | ppm | 78% | 10.2% | 91% |
| Embodiment 26 | 3643 | ppm | 77% | 10.1% | 90% |
| Embodiment 27 | 3687 | ppm | 76% | 10.1% | 91% |
| Embodiment 28 | 3678 | ppm | 77% | 9.9% | 92% |
| Embodiment 29 | 3599 | ppm | 79% | 10.1% | 90% |
| Embodiment 30 | 3645 | ppm | 79% | 10.0% | 91% |
| Embodiment 31 | 3657 | ppm | 78% | 10.0% | 92% |
| Embodiment 32 | 3663 | ppm | 82% | 9.3% | 96% |
| Embodiment 33 | 3659 | ppm | 84% | 9.1% | 98% |
| Comparative | 4723 | ppm | 61.1% | 15.5% | 68% |
| Embodiment 1 | | | | | |
| Comparative | 2723 | ppm | 72.2% | 16.1% | 70% |
| Embodiment 2 | | | | | |
| Comparative | 4571 | ppm | 68.7% | 14.9% | 69% |
| Embodiment 3 | | | | | |

As can be seen from Table 1 and Table 2, in Embodiments 1 to 33 versus Comparative Embodiments 1 to 3, both the cycle capacity retention rate and the hot oven test pass rate at 130° C. after cycles are noticeably increased, and the cycle thickness growth rate is noticeably reduced. That is because the polymer adhesive layer increases the adhesion between the positive electrode plate and the separator, reduces the interlayer spacing between the positive electrode plate and the separator, reduces the reaction rate at the interface between the positive active material and the electrolytic solution, and inhibits gassing of the positive electrode, thereby improving the performance of the electrochemical device.

The Co dissolution amount in Embodiments 1 to 33 is lower than that in Comparative Embodiments 1 and 3, indicating that the structural stability of the positive active material can be effectively improved after the positive active material is doped with metals such as Mg and Al or coated with metal oxide, so that the Co dissolution amount is reduced.

In Comparative Embodiment 2 versus Embodiments 1 to 33, the cycle capacity retention rate and the hot oven test pass rate at 130° C. after cycles decline, and the cycle thickness growth rate rises noticeably, indicating that even if doping metals such as Mg and Al are added and the metal oxide is applied as a coating, no effect is seen in improving the performance indicators of the battery such as the cycle capacity retention rate, the hot oven test pass rate at 130° C. after cycles, and the cycle thickness growth rate, and such performance indicators have to be improved by adding a polymer adhesive layer.

In summary, the electrochemical device according to this application can not only effectively reduce Co dissolution, but also suppress gassing of the positive electrode, thereby significantly improving the high-voltage cycle capacity retention performance of the electrochemical device and reducing the volume expansion of the electrochemical device.

What is described above is merely preferred embodiments of this application, but is not intended to limit this application. Any modifications, equivalent substitutions, and improvements made within the spirit and principles of this application still fall within the protection scope of this application.

11. An electrochemical device, comprising a positive electrode plate, a negative electrode plate, a separator, and an electrolytic solution, wherein the separator is disposed between the positive electrode plate and the negative electrode plate;
the positive electrode plate comprises a positive active material, and the positive active material comprises lithium transition metal oxide particles represented by a chemical formula LiₐCoₓM1_{y}M2_{z}O₂, wherein 0.95≤a≤1.05, 0.05<x<1, 0≤y≤0.9, 0<z≤0.2, x+y+z=1; M1 is one or two selected from the group consisting of Ni and Mn; and M2 is at least one selected from the group consisting of Mg, Al, Ti, La, Y, and Zr; and
the separator comprises a porous substrate and a polymer adhesive layer, the polymer adhesive layer is disposed between the porous substrate and the positive electrode plate, and an adhesive force of the polymer adhesive layer between the positive electrode plate is 3 N/m to 100 N/m.

12. The electrochemical device according to claim 11, wherein the lithium transition metal oxide particles are doped with M2.

13. The electrochemical device according to claim 11, wherein, based on a total weight of the positive active material, a content of the M2 is 1000 ppm to 20000 ppm.

14. The electrochemical device according to claim 12, wherein, based on a total weight of the positive active material, a content of the M2 is 1000 ppm to 20000 ppm.

15. The electrochemical device according to claim 11, wherein an oxide of the M2 is disposed on a surface of the lithium transition metal oxide particles, and the oxide of the M2 is at least one selected from the group consisting of Al₂O₃, MgO, TiO₂, La₂O₃, Y₂O₃, and ZrO₂.

16. The electrochemical device according to claim 11, wherein the positive active material satisfies the relation:
1≤Dᵥ₉₉/Dᵥ₅₀≤2,
wherein, Dᵥ₉₉ is a particle diameter of the positive active material measured when a cumulative volume percentage of measured particles calculated from a small-diameter side reaches 99% of a total volume in a volume-based particle size distribution; and Dᵥ₅₀ is a particle diameter of the positive active material measured when the cumulative volume percentage of measured particles calculated from a small-diameter side reaches 50% of the total volume in the volume-based particle size distribution.

17. The electrochemical device according to claim 11, wherein the polymer adhesive layer comprises polymer particles, and the polymer particles have at least one characteristic from the group consisting of:
(a) the polymer particles are core-shell structures;
(b) an average particle diameter of the polymer particles is 200 nm to 2000 nm;
(c) a number of layers of the polymer particles in the polymer adhesive layer is less than or equal to 4; and
(d) a swelling degree of the polymer particles swollen in the electrolytic solution is 20% to 1000%.

18. The electrochemical device according to claim 11, wherein an areal percentage of an orthographic projection of the polymer adhesive layer on a surface of the porous substrate is 15% to 85%.

19. The electrochemical device according to claim 17, wherein the polymer particles comprise at least one of polyvinylidene dichloride, poly(vinylidene fluoride-co-hexafluoropropylene), poly(styrene-co-butadiene), polyacrylonitrile, poly(butadiene-co-acrylonitrile), polyacrylic acid, polyacrylate, or poly(acrylate-co-styrene).

20. The electrochemical device according to claim 11, further comprising an inorganic compound layer disposed between the porous substrate and the polymer adhesive layer, and the inorganic compound layer comprises inorganic particles and a binder.

21. An electronic device, comprises an electrochemical device, the electrochemical device comprises a positive electrode plate, a negative electrode plate, a separator, and an electrolytic solution, wherein the separator is disposed between the positive electrode plate and the negative electrode plate;
the positive electrode plate comprises a positive active material, and the positive active material comprises lithium transition metal oxide particles represented by a chemical formula LiₐCoₓM1_{y}M2_{z}O₂, wherein 0.95≤a≤1.05, 0.05<x<1, 0≤y≤0.9, 0<z≤0.2, x+y+z=1, M1 is one or two selected from the group consisting of Ni and Mn, and M2 is at least one selected from the group consisting of Mg, Al, Ti, La, Y, and Zr; and
the separator comprises a porous substrate and a polymer adhesive layer, the polymer adhesive layer is disposed between the porous substrate and the positive electrode plate, and an adhesive force of the polymer adhesive layer between the positive electrode plate is 3 N/m to 100 N/m.

22. The electronic device according to claim 21, wherein the lithium transition metal oxide particles are doped with the M2.

23. The electronic device according to claim 21, wherein, based on a total weight of the positive active material, a content of the M2 is 1000 ppm to 20000 ppm.

24. The electronic device according to claim 22, wherein, based on a total weight of the positive active material, a content of the M2 is 1000 ppm to 20000 ppm.

25. The electronic device according to claim 21, wherein an oxide of the M2 is disposed on a surface of the lithium transition metal oxide particles, and the oxide of the M2 is at least one selected from the group consisting of Al₂O₃, MgO, TiO₂, La₂O₃, Y₂O₃, and ZrO₂.

26. The electronic device according to claim 21, wherein the positive active material satisfies the relation:
1≤Dᵥ₉₉/Dᵥ₅₀≤2,
wherein, Dᵥ₉₉ is a particle diameter of the positive active material measured when a cumulative volume percentage of measured particles calculated from a small-diameter side reaches 99% of a total volume in a volume-based particle size distribution; and Dᵥ₅₀ is a particle diameter of the positive active material measured when the cumulative volume percentage of measured particles calculated from a small-diameter side reaches 50% of the total volume in the volume-based particle size distribution.

27. The electronic device according to claim 21, wherein the polymer adhesive layer comprises polymer particles, and the polymer particles have at least one characteristic from the group consisting:
(a) the polymer particles are core-shell structures;
(b) an average particle diameter of the polymer particles is 200 nm to 2000 nm;
(c) a number of layers of the polymer particles in the polymer adhesive layer is less than or equal to 4; and
(d) a swelling degree of the polymer particles swollen in the electrolytic solution is 20% to 1000%.

28. The electronic device according to claim 21, wherein an areal percentage of an orthographic projection of the polymer adhesive layer on a surface of the porous substrate is 15% to 85%.

29. The electronic device according to claim 27, wherein the polymer particles comprise at least one of polyvinylidene dichloride, poly(vinylidene fluoride-co-hexafluoropropylene), poly(styrene-co-butadiene), polyacrylonitrile, poly(butadiene-co-acrylonitrile), polyacrylic acid, polyacrylate, or poly(acrylate-co-styrene).

30. The electronic device according to claim 21, further comprising an inorganic compound layer disposed between the porous substrate and the polymer adhesive layer, and the inorganic compound layer comprises inorganic particles and a binder.
